(19) United States
(12) Patent Application Publication
(10) Pub. No.: US 2022/0065200 A1
(43) Pub. Date: Mar. 3, 2022

(54) ENGINE SYSTEM

(71) Applicant: Mazda Motor Corporation, Hiroshima (JP)

(72) Inventors: Takeshi Nagasawa, Aki-gun (JP); Ryo Kiyosue, Aki-gun (JP)

(21) Appl. No.: 17/372,714

(22) Filed: Jul. 12, 2021

(30) Foreign Application Priority Data
Aug. 26, 2020 (JP) 2020-142328

(51) Int. Cl. F02M 25/022; F02M 25/03; F02B 47/02

(52) U.S. Cl. CPC F02M 25/0227; F02M 25/0222; F02B 47/02; F02M 25/0224; F02M 25/03

(57) ABSTRACT

An engine system is provided, which includes an engine configured to generate a motive force for a vehicle by combusting a mixture gas of fuel and intake air, a water injector configured to inject heated water into a combustion chamber of the engine, and a controller configured to control the water injector to inject the water into the combustion chamber during an expansion stroke of the engine. The controller acquires a demanded engine load of the engine, and controls the water injector to increase an amount of water injection when the demanded engine load is within a first-load range, compared to when the demanded engine load is within a second-load range where the engine load is higher than in the first-load range.

### TECHNICAL FIELD

The present disclosure relates to an engine system which injects water into a combustion chamber of an engine.

### BACKGROUND OF THE DISCLOSURE

For example, JP2009-168039A discloses this type of technology. In detail, JP2009-168039A discloses a technology for a compression ignition engine in which a mixture gas is combusted by compression ignition. In this technology, heated water, in particular, subcritical water at or above 250° C. and at or above 10 MPa, is injected into a combustion chamber during a compression stroke and an expansion stroke. Such an injection of water into the combustion chamber improves emissions (e.g., reduces emissions of NOₓ and CO), and the output of the engine.

Meanwhile, when a load of the engine is comparatively low, a pumping loss of the engine increases. Therefore, basically, when the engine load is comparatively low, an amount of fuel injection is required to be increased by the amount of pumping loss so as to achieve a desired output of the engine. In terms of this, the present inventors thought that, if water is effectively injected into the combustion chamber when the engine load is comparatively low, such a pumping loss is compensated by an improvement in the output of the engine (increase in an engine work) resulting from the water injection. Therefore, the increase in the amount of fuel injection can be suppressed.

### SUMMARY OF THE DISCLOSURE

Therefore, one purpose of the present disclosure is to provide an engine system, capable of appropriately injecting water into a combustion chamber so as to compensate a pumping loss in an engine when a load of the engine is comparatively low.

According to one aspect of the present disclosure, an engine system is provided, which includes an engine configured to generate a motive force for a vehicle by combusting a mixture gas of fuel and intake air, a water injector configured to inject heated water into a combustion chamber of the engine, and a controller configured to control the water injector to inject the water into the combustion chamber during an expansion stroke of the engine. The controller acquires a demanded engine load of the engine, and controls the water injector to increase an amount of water injection when the demanded engine load is within a first-load range, compared to when the demanded engine load is within a second-load range where the engine load is higher than in the first-load range.

According to this configuration, when water is injected during the expansion stroke of the engine, and the demanded engine load is within the first-load range where the engine load is comparatively low, the controller controls the water injector to increase the water-injection amount compared to when the demanded engine load is within the second-load range where the engine load is comparatively high. In this manner, when the water-injection amount is increased in the first-load range, the pumping loss when the engine load is low can be compensated by the increase in the output of the engine (increase in the engine work) by the water injection. As a result, the increase in the amount of fuel injection to handle the pumping loss can be suppressed.

When the demanded engine load is within the first-load range, the controller may control the water injector to advance a start timing of the water injection compared to when the demanded engine load is within the second-load range. According to this configuration, since the water injection is started earlier in the first-load range where the engine load is comparatively low, the pumping loss when the engine load is low can effectively be compensated by the water injection.

The controller may control the water injector to further inject the water into the combustion chamber during a compression stroke of the engine. According to this configuration, since the water injection is further performed during the compression stroke, the combustion chamber is cooled down by the injected water, and thereby knocking can be reduced and the emissions can be improved. Moreover, the water injected during the compression stroke in this manner vaporizes to contribute to the expansion work, thus promoting the improvement in the output of the engine.

The water injector may directly inject the heated water into the combustion chamber of the engine. According to this configuration, the expansion caused by the vaporization of the heated water can directly be converted into the engine output.

The engine system may further include a heat exchanger provided to an exhaust pipe of the engine and configured to heat water with heat of exhaust gas of the engine. The water heated by the heat exchanger may be supplied to the water injector. According to this configuration, since water to be injected into the combustion chamber by the water injector is heated by utilizing the heat of the exhaust gas, the exhaust heat is recovered, and thereby thermal efficiency of the engine improves.

According to another aspect of the present disclosure, an engine system is provided, which includes an engine configured to generate a motive force for a vehicle by combusting a mixture gas of fuel and intake air, a water injector configured to inject heated water into a combustion chamber of the engine, and a controller configured to control the water injector to inject the water into the combustion chamber during an expansion stroke of the engine. The controller acquires a demanded engine load of the engine, and controls the water injector to increase an amount of water injection as the demanded engine load decreases. Also according to this configuration, the pumping loss when the engine load is low can be compensated by the increase in the output of the engine by the water injection, and the increase in the amount of fuel injection can be suppressed.

The controller may control the water injector to advance a start timing of the water injection as the demanded engine load decreases.

The controller may control the water injector to increase the amount of water injection as the demanded engine load decreases.

The controller may change a ratio of the amount of water injection to an amount of fuel injection, and control the water injector to increase the amount of water injection as the demanded engine load decreases.

### BRIEF DESCRIPTION OF DRAWINGS

FIG. 1 is a schematic view illustrating a configuration of an engine system according to one embodiment of the present disclosure.

FIG. 2 is a block diagram illustrating an electrical configuration of the engine system according to this embodiment.

FIG. 3 is an explanatory diagram of an engine-load range used in a control of water injection according to this embodiment.

FIGS. 4A and 4B are time charts illustrating the water injection control according to this embodiment.

FIG. 5 is a flowchart illustrating the water injection control according to this embodiment.

FIG. 6 is an explanatory diagram of a control of water injection according to another embodiment of the present disclosure.

FIG. 7 is an explanatory diagram of a control of water injection according to still another embodiment of the present disclosure.

### DETAILED DESCRIPTION OF THE DISCLOSURE

Hereinafter, engine systems according to embodiments of the present disclosure are described with reference to the accompanying drawings.

### [Configuration of Engine System]

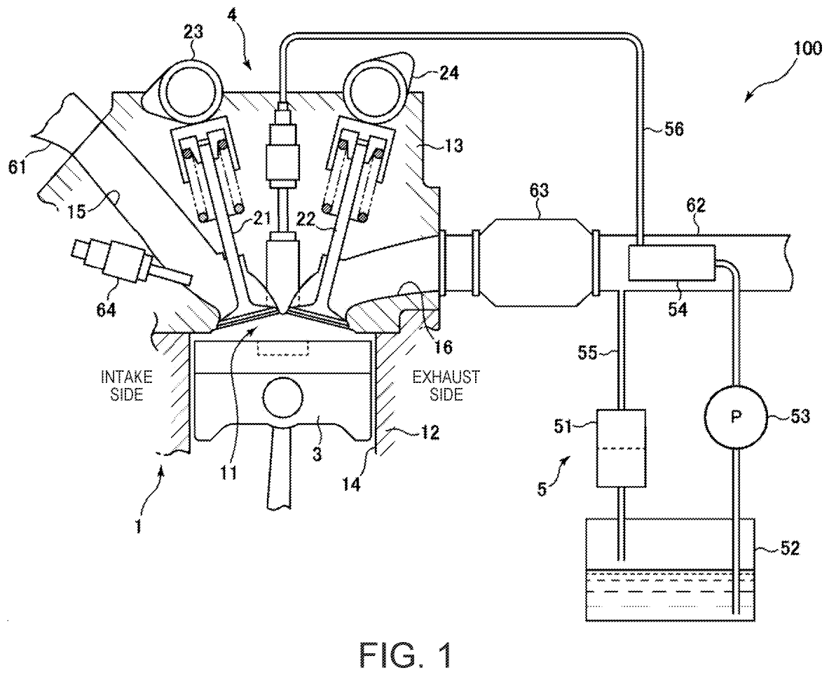

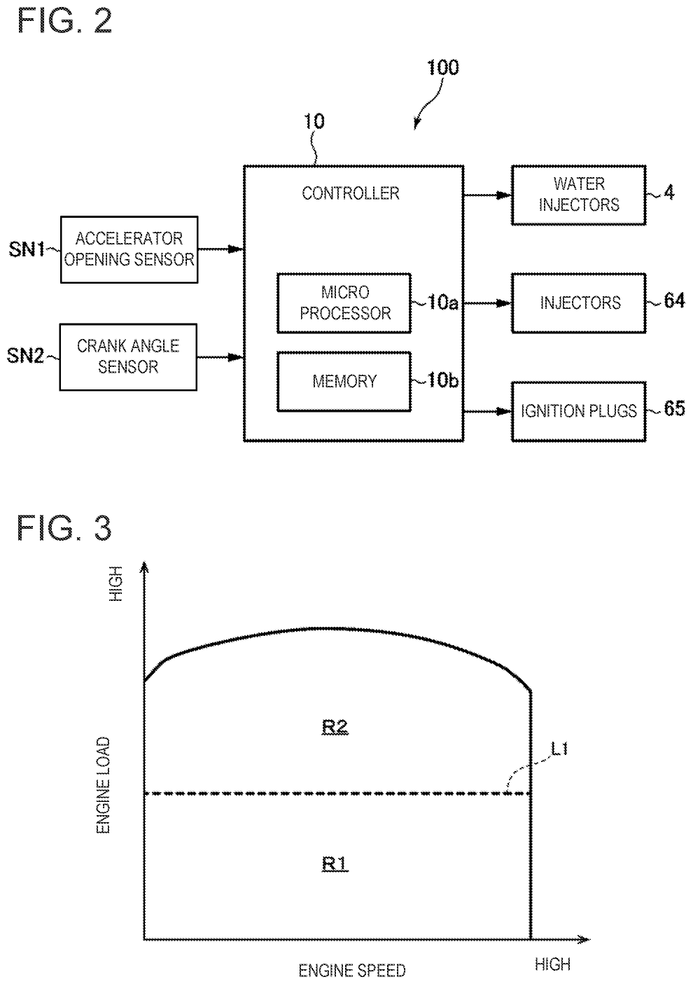

First, a configuration of an engine system according to one embodiment of the present disclosure is described with reference to FIGS. 1 and 2. FIG. 1 is a schematic view illustrating the configuration of the engine system according to this embodiment. FIG. 2 is a block diagram illustrating an electrical configuration of the engine system according to this embodiment.

As illustrated in FIG. 1, an engine system 100 according to this embodiment mainly includes an engine 1 which generates a motive force for a vehicle by combusting a mixture gas of fuel and air, a water injector 4 which injects water into the engine 1, and a water supplier 5 which supplies water to the water injector 4. The engine 1 is a four-stroke reciprocating engine which operates by repeating an intake stroke, a compression stroke, an expansion stroke, and an exhaust stroke inside a combustion chamber 11. The engine 1 is mounted on a vehicle having four wheels. The vehicle travels according to the operation of the engine 1. Fuel of the engine 1 is gasoline in this example. The fuel may be any liquid fuel at least containing gasoline. The fuel may be gasoline containing bioethanol, for example.

The engine 1 is provided with a cylinder block 12 and a cylinder head 13 provided onto the cylinder block 12. A plurality of cylinders 14 are formed inside the cylinder block 12. The engine 1 is a multi-cylinder engine. Only one cylinder 14 is illustrated in FIG. 1. A piston 3 is inserted into each cylinder 14. The piston 3 reciprocates inside the cylinder 14. Although illustration is omitted, the piston 3 is coupled to a crankshaft via a connecting rod. The piston 3 forms the combustion chamber 11 with the cylinder 14 and the cylinder head 13. Note that the “combustion chamber” as used herein means a space formed by the piston 3, the cylinder 14, and the cylinder head 13, regardless of the position of the piston 3.

The cylinder head 13 is formed with intake ports 15 for the respective cylinders 14. The intake ports 15 communicate with the respective combustion chambers 11. Each intake port 15 is provided with an intake valve 21. The intake valve 21 opens and closes the intake port 15. The intake valve 21 opens and closes according to a rotation of a cam 23. Note that although a valve mechanism which opens and closes the intake valve 21 is a linear-motion type in this example, the configuration of the valve mechanism of the intake valve 21 is not particularly limited.

Moreover, the cylinder head 13 is formed with exhaust ports 16 for the respective cylinders 14. The exhaust ports 16 also communicate with the respective combustion chambers 11. Each exhaust port 16 is provided with an exhaust valve 22. The exhaust valve 22 opens and closes the exhaust port 16. The exhaust valve 22 opens and closes according to a rotation of a cam 24. Note that although a valve mechanism which opens and closes the exhaust valve 22 is a linear-motion type in this example, the configuration of the valve mechanism of the exhaust valve 22 is not particularly limited.

An intake pipe 61 is connected to one side (left side in FIG. 1) of the engine 1. The intake pipe 61 communicates with the intake ports 15. Gas to be introduced into the combustion chamber 11 flows inside the intake pipe 61. Although not illustrated, a throttle valve is provided to the intake pipe 61. An exhaust pipe 62 is connected to the other side (right side in FIG. 1) of the engine 1. The exhaust pipe 62 communicates with the exhaust ports 16. Exhaust gas discharged from the combustion chambers 11 flows inside the exhaust pipe 62. The exhaust pipe 62 is provided with a catalytic converter 63. The catalytic converter 63 has a three-way catalyst, for example. The catalytic converter 63 purifies the exhaust gas.

Injectors 64 are attached to the cylinder head 13 for the respective cylinders 14. The injectors 64 are provided to the respective intake ports 15. Each injector 64 injects fuel into the intake port 15. Although not illustrated in detail, the injector 64 is, for example, a fuel injection valve of a multi-hole type with a plurality of nozzle holes. Note that the attached position of the injector 64 illustrated in FIG. 1 is one example. The injector 64 may be provided to the combustion chamber 11 instead of to the intake port 15. That is, the injector 64 may directly inject fuel into the combustion chamber 11.

Moreover, although not illustrated in FIG. 1 for convenience, an ignition plug 65 (see FIG. 2) is attached to the cylinder head 13 for each of the respective cylinders 14. Each ignition plug 65 is attached to a ceiling part of the combustion chamber 11. When the ignition plug 65 forcibly ignites the mixture gas, the mixture gas combusts by SI (Spark Ignition) combustion caused by flame propagation. Note that the engine 1 may be such that unburned mixture gas undergoes CI (Compression Ignition) combustion by self-ignition as a result of an increase in temperature inside the combustion chamber 11 due to heat generated by SI combustion, and/or an increase in pressure inside the combustion chamber 11 due to the flame propagation. That is, the engine 1 may be a compression-ignition gasoline engine in which at least part of the mixture gas combusts by compression ignition.

Meanwhile, the water supplier 5 heats water and supplies the heated water to the water injectors 4. Each water injector 4 directly injects the heated water supplied from the water supplier 5 into the combustion chamber 11 of the engine 1. The engine 1 increases the expansion work due to the vaporization of the heated water by injecting the heated water into the combustion chamber 11 so as to increase an amount of piston work of the engine 1, that is, to improve the output of the engine. Moreover, the engine 1 injects the heated water into the combustion chamber 11 and cools inside of the combustion chamber 11 so that abnormal combustion is reduced, and the emissions improve (emissions of NOₓ and CO are decreased).

The water injectors 4 are attached to the cylinder head 13 for the respective cylinders 14. Each water injector 4 is attached to the ceiling part of the combustion chamber 11. The water injector 4 is provided at a substantially intermediate position between the intake side and the exhaust side of the engine 1. The water injector 4 is provided separately from the ignition plug 65.

The water supplier 5 is connected to the water injectors 4. The water supplier 5 condenses water contained in the exhaust gas, and supplies the condensed water to the water injectors 4. The water supplier 5 has a condenser 51, a water tank 52, a water pump 53, and a heat exchanger 54. The condenser 51 condenses the water contained in the exhaust gas which is extracted from the exhaust pipe 62. The condenser 51 is connected to an extraction pipe 55. The extraction pipe 55 connects the exhaust pipe 62 to the condenser 51. The water tank 52 stores the water condensed by the condenser 51. The water tank 52 is connected to the water injectors 4 through a first supply pipe 56. The water pump 53 and the heat exchanger 54 are interposed in the first supply pipe 56. The water pump 53 draws the water inside the water tank 52 and discharges the water to the heat exchanger 54. The heat exchanger 54 is attached to the exhaust pipe 62. The heat exchanger 54 exchanges heat between the exhaust gas and the water. The water is heated by the heat of the exhaust gas of the engine 1. The water at a high temperature and a high pressure, which is pressurized by the water pump 53 and heated by the heat exchanger 54, is sent to the water injectors 4. Preferably, heated water at or above 100° C. and at or above 3 MPa is sent to the water injectors 4. More preferably, heated water at or above 250° C. and at or above 10 MPa (corresponding to subcritical water) is sent to the water injectors 4.

Moreover, as illustrated in FIG. 2, the engine system 100 has a controller 10. The controller 10 is comprised of a circuit, and is a control unit based on a well-known microcomputer. The controller 10 is comprised of one or more microprocessor(s) 10a as a CPU (Central Processing Unit) which executes a program, memory 10b which is comprised of, for example, RAM (Random Access Memory) and ROM (Read Only Memory) and stores the program and data, and an input-and-output bus which inputs and outputs electrical signals. For example, the controller 10 is comprised of an ECU (Electronic Control Unit).

Various sensors are connected to the controller 10. In detail, an accelerator opening sensor SN1 and a crank angle sensor SN2 are mainly connected to the controller 10. The accelerator opening sensor SN1 is attached to an accelerator pedal mechanism (not illustrated), and detects an accelerator opening corresponding to an operated amount of an accelerator pedal. The crank angle sensor SN2 is attached to the engine 1, and detects a rotational angle of the crankshaft (corresponding to an engine speed). The sensors SN1 and SN2 output to the controller 10 detection signals corresponding to the detected values.

The controller 10 determines an operating state of the engine 1 based on the detection signals of the accelerator opening sensor SN1 and the crank angle sensor SN2, and calculates an amount of control for each device based on a control logic defined in advance. The control logic is stored in the memory 10b. The control logic includes a calculation of a target amount and/or the control amount based on a map stored in the memory 10b. The controller 10 outputs control signals corresponding to the calculated control amounts, to the water injector 4, the injector 64, the ignition plug 65, etc. Particularly, in this embodiment, the controller 10 controls the water injector 4 to inject heated water into the combustion chamber 11 at least during an expansion stroke of the engine 1. Moreover, the controller 10 acquires a demanded engine load corresponding to a torque demanded to be applied to the vehicle, based on the accelerator opening detected by the accelerator opening sensor SN1, and controls an amount and a timing of the water injection from the water injector 4, according to the demanded engine load.

### [Control of Water Injection]

Next, a control of the water injection by the controller 10 according to this embodiment of the present disclosure is described in detail.

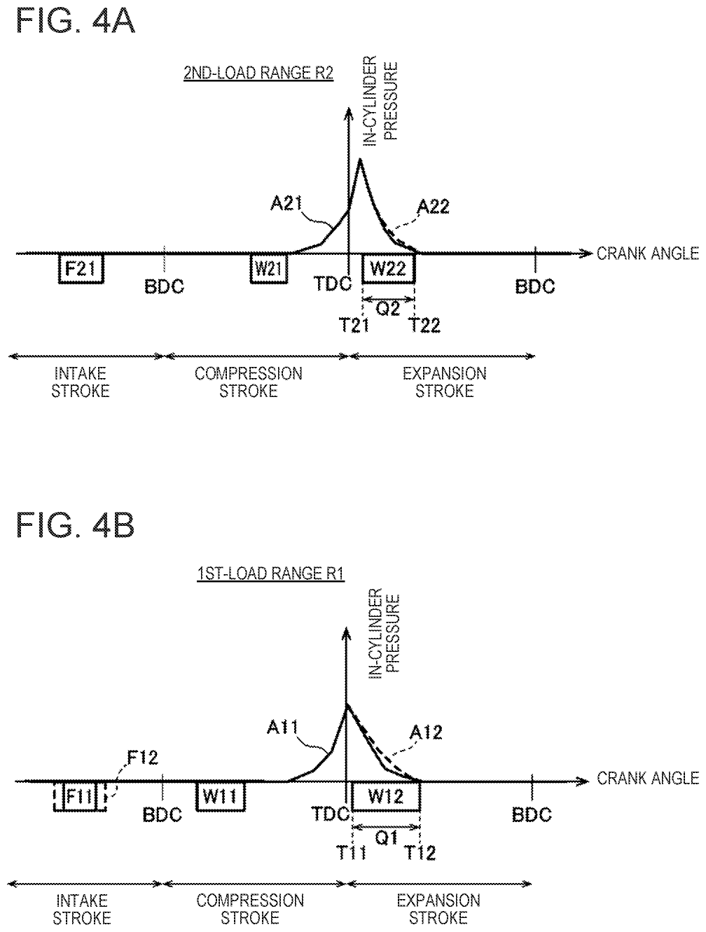

First, a basic concept of the water injection control according to this embodiment is described with reference to FIGS. 3 and 4.

In FIG. 3, the horizontal axis indicates an engine speed, and the vertical axis indicates an engine load. In detail, FIG. 3 illustrates a first-load range R1 where the engine load is comparatively low, and a second-load range R2 where the engine load is comparatively high. The first-load range R1 is a range where the engine load is below a given load L1, and the second-load range R2 is a range where the engine load is above the given load L1.

FIGS. 4A and 4B are time charts illustrating the water injection control according to this embodiment. In detail, FIG. 4A is a time chart illustrating the water injection control in the second-load range R2, and FIG. 4B is a time chart illustrating the water injection control in the first-load range R1. In FIGS. 4A and 4B, the horizontal axis indicates the crank angle and the vertical axis indicates an in-cylinder pressure, and the fuel injection and the water injection are schematically illustrated.

As illustrated in FIGS. 4A and 4B, in this embodiment, in both of the second-load range R2 and the first-load range R1, the controller 10 causes the injector 64 to inject fuel during an intake stroke (see F21 and F11), causes the water injector 4 to inject the heated water during a compression stroke (see W21 and W11), and causes the water injector 4 to inject the heated water during an expansion stroke (see W22 and W12). During the compression stroke, the water injected into the combustion chamber 11 cools the combustion chamber 11 so as to mainly reduce knocking and to improve the emissions. In contrast, during the expansion stroke, an expansion work caused by vaporization of the water injected into the combustion chamber 11 mainly improves the output of the engine. Here, in FIGS. 4A and 4B, changes in the in-cylinder pressure indicated by reference characters A21 and All correspond to a work by fuel, and changes in the in-cylinder pressure indicated by reference characters A22 and A12 correspond to a work by the water injection.

Particularly, in this embodiment, when water is injected during the expansion stroke, and the demanded engine load corresponding to the demanded torque according to the acceleration opening is within the first-load range R1, the controller 10 controls the water injector 4 to increase the water-injection amount compared to when the demanded engine load is within the second-load range R2 (see W22 and W12) (the engine speed is assumed to be the same in both cases, and this is applied similarly below). In detail, the controller 10 causes the water injector 4 to inject water in an amount Q2 in the second-load range R2 (the water-inj ection amount Q2 uniquely corresponds to a period of time of water injection from a water-inj ection start timing T21 to a water-inj ection end timing T22). On the other hand, in the first-load range R1, the controller 10 causes the water injector 4 to inject water in an amount Q1 larger than the water-injection amount Q2 (the water-injection amount Q1 uniquely corresponds to a period of time of water injection from a water-injection start timing T11 to a water-injection end timing T12). By the amount of water injection being increased in the first-load range R1 where the engine load is comparatively low, a pumping loss when the engine load is low can be compensated by the improvement in the output of the engine (the increase in the engine work) resulting from the water injection. Therefore, an increase in an amount of fuel injection can be suppressed.

Moreover, in this embodiment, when water is injected during the expansion stroke, the controller 10 controls the water injector 4 to advance a start timing of the water injection in the first-load range R1 compared to in the second-load range R2 (see W22 and W12). In detail, the controller 10 starts the water injection from the water injector 4 at the timing T21 in the second-load range R2, while the controller 10 starts, in the first-load range R1, the water injection from the water injector 4 at the timing T11 earlier than the timing T21. In this manner, by the water injection being started earlier in the first-load range R1 where the engine load is comparatively low, the pumping loss when the engine load is low can be compensated by the water injection. Therefore, the increase in the amount of fuel injection can be suppressed.

Here, in the first-load range R1, if the amount of water injection and the start timing of the water injection are set regardless of a magnitude of the engine load (e.g., the water-injection amount Q2 and the water-injection start timing T21 equivalent to in the second-load range R2), a fuel-injection amount F12 is required in order to achieve a given output of the engine. However, as described above, if the water-injection amount Q1 which is comparatively large, and the water-injection start timing T11 which is comparatively early, are applied in the first-load range R1, the given output of the engine can be achieved by a fuel-injection amount F11 smaller than the fuel-injection amount F12.

Note that, for example, in the second-load range R2, the controller 10 sets the water-injection start timing T21 at a crank angle of 15° after a compression top dead center (TDC), and sets the water-injection end timing T22 at a crank angle of 45° after the compression TDC. On the other hand, in the first-load range R1, the controller 10 sets the water-injection start timing T11 at a crank angle of 5° after the compression TDC, and sets the water-injection end timing T12 at a crank angle of 45° after the compression TDC. Moreover, the given load L1, which is the border between the first-load range R1 and the second-load range R2, is defined to be a value at which, for example, the pumping loss to be handled by the increase in the amount of fuel injection occurs when the engine load is below the load L1.

Note that when water is injected during the compression stroke, the controller 10 increases the amount of water injection and advances the start timing of the water injection in the first-load range R1, compared to in the second-load range R2. In other words, in the second-load range R2, the amount of water injection is reduced and the start timing of the water injection is retarded compared to in the first-load range R1 (see W21 and W11). As a result, in both of the first-load range R1 and the second-load range R2, the reduction in knocking and the improvement in the emissions by the water injection can appropriately be secured.

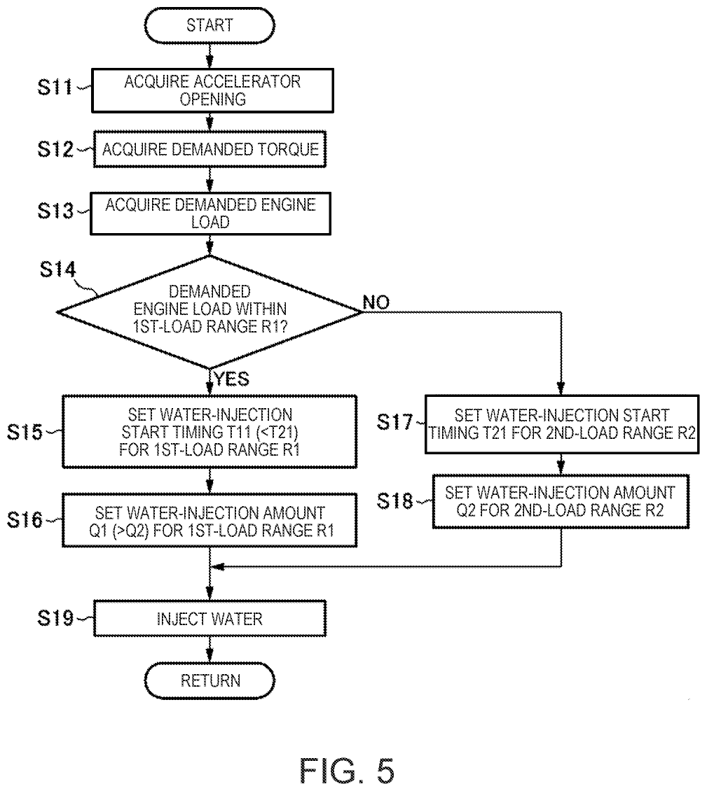

Next, a concrete flow of processing in the water injection control is described with reference to FIG. 5. FIG. 5 is a flowchart illustrating the water injection control by the engine system according to this embodiment. This flow is repeatedly executed by the microprocessor 10a of the controller 10 in a given cycle based on the program stored in the memory 10b.

First, at step S11, the controller 10 acquires the accelerator opening detected by the accelerator opening sensor SN1. Then, at step S12, the controller 10 acquires the torque demanded by a driver based on the accelerator opening acquired at step S11. For example, the controller 10 refers to a map (e.g., a map prepared for each of various speeds and gear stages) in which the demanded torque to be applied is defined so as to be associated with the accelerator opening, and determines the demanded torque corresponding to the current accelerator opening. Then, at step S13, the controller 10 acquires the demanded engine load which is a load of the engine 1 at which the demanded torque acquired at step S12 is achieved. The controller 10 refers to a map in which the torque is associated with the load, or executes a given calculation to convert the torque into the load, in order to acquire the demanded engine load. Note that the demanded engine load is not limited to be acquired based on the accelerator opening as described above, but may be acquired in various known methods.

Next, at step S14, the controller 10 determines whether the demanded engine load acquired at step S13 is within the first-load range R1, that is, whether the demanded engine load is below the given load L1. As a result of the determination, if the demanded engine load is not within the first-load range R1 (step S14: NO), that is, if the demanded engine load is within the second-load range R2, the controller 10 executes processings of steps S17 and S18.

At steps S17 and S18, the controller 10 sets the water-injection start timing T21 and the water-injection amount Q2, respectively, for the water injection during the expansion stroke in the second-load range R2 where the engine load is comparatively high. In detail, at step S17, the controller 10 sets the water-injection start timing T21, which is comparatively late, for the second-load range R2, and at step S18, the controller 10 sets the water-injection amount Q2, which is comparatively small, for the second-load range R2. The water-injection start timing T21 and the water-injection amount Q2 are defined in advance such that, when water is injected during the expansion stroke in the second-load range R2 where the engine load is comparatively high, the improvement in the output of the engine is appropriately secured while reducing an influence of the water injection on the combustion when the engine load is high.

Next, at step S19, the controller 10 controls the water injector 4 to inject the heated water based on the water-injection start timing T21 and the water-injection amount Q2 set at steps S17 and S18, respectively. That is, the controller 10 outputs the control signal to the water injector 4 so as to inject water in the amount Q2 from the water-injection start timing T21 during the expansion stroke.

On the other hand, if the demanded engine load is within the first-load range R1 (step S14: YES), the controller 10 executes steps S15 and S16. At steps S15 and S16, the controller 10 sets the water-injection start timing T11 and the water-injection amount Q1, respectively, for the water injection during the expansion stroke in the first-load range R1 where the engine load is comparatively low. In detail, at step S15, the controller 10 sets the water-injection start timing T11 (earlier than the water-injection start timing T21 for the second-load range R2; T1<T21), and at step S16, the controller 10 sets the water-inj ection amount Q1 (larger than the water-injection amount Q2 for the second-load range R2; Q1>Q2). The water-injection start timing T11 and the water-injection amount Q1 are defined in advance such that, when water is injected during the expansion stroke in the first-load range R1 where the engine load is comparatively low, the pumping loss when the engine load is low is appropriately compensated by improving the output of the engine by the water injection is appropriately compensated.

Next, at step S19, the controller 10 controls the water injector 4 to inject the heated water based on the water-injection start timing T11 and the water-injection amount Q1 set at steps S15 and S16, respectively. That is, the controller 10 outputs the control signal to the water injector 4 so as to inject water in the amount Q1 from the water-injection start timing T11 during the expansion stroke.

### [Operation and Effects]

As described above, according to this embodiment, when water is injected during the expansion stroke of the engine 1, and the demanded engine load is within the first-load range R1, the controller 10 controls the water injector 4 to increase the amount of water injection compared to when the demanded engine load is within the second-load range R2 where the engine load is higher than the first-load range R1. In this manner, when the amount of water injection is increased in the first-load range R1 where the engine load is comparatively low, the pumping loss when the engine load is low can be compensated by the improvement in the output of the engine (increase in the engine work) by the water injection. As a result, the increase in the amount of fuel injection to handle the pumping loss can be suppressed.

Moreover, according to this embodiment, when water is injected during the expansion stroke of the engine 1, and the demanded engine load is within the first-load range R1, the controller 10 controls the water injector 4 to advance the start timing of the water injection compared to when the demanded engine load is within the second-load range R2. In this manner, when the water injection is started earlier in the first-load range R1 where the engine load is comparatively low, the pumping loss when the engine load is low can effectively be compensated by the water injection.

Moreover, according to this embodiment, since the controller 10 controls the water injector 4 to further inject water during the compression stroke of the engine 1, the combustion chamber 11 is cooled down by the injected water, and thereby knocking can be reduced and the emissions can be improved. Moreover, the water injected during the compression stroke in this manner vaporizes and performs the expansion work, thus contributing to the improvement in the output of the engine.

Moreover, according to this embodiment, since the water injector 4 directly injects the heated water into the combustion chamber 11 of the engine 1, the expansion caused by the vaporization of the injected water can directly be converted into the piston work of the engine.

Moreover, according to this embodiment, the engine system 100 further has the heat exchanger 54 which is provided to the exhaust pipe 62 of the engine 1, and heats water by the heat of the exhaust gas of the engine 1, and the water heated by the heat exchanger 54 is supplied to the water injector 4. Therefore, since water to be injected into the combustion chamber 11 by the water injector 4 is heated by utilizing the heat of the exhaust gas, the exhaust heat is recovered, and thereby thermal efficiency of the engine 1 improves.

### [Other Embodiments]

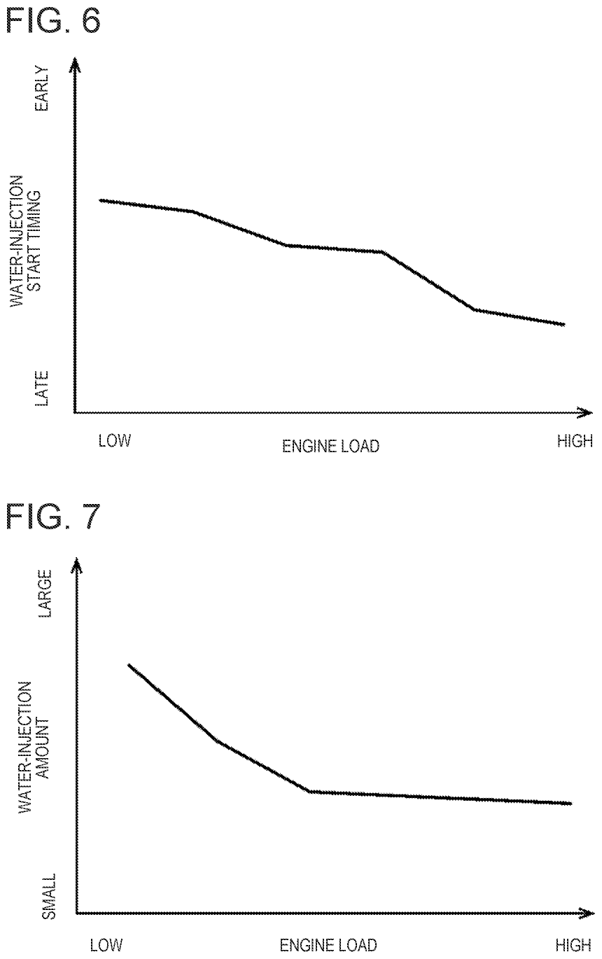

Next, other embodiments modified from the above embodiment are described. In the embodiment described above, the water-injection start timing T11 and the water-injection start timing T21 are switched between the first-load range R1 and the second-load range R2 (e.g., see FIG. 5). However, in another embodiment, the start timing of the water injection may be changed according to the load of the engine. In detail, in another embodiment, as illustrated in FIG. 6 (the horizontal axis indicates the engine load, and the vertical axis indicates the water-injection start timing), when water is injected during the expansion stroke of the engine 1, the controller 10 may advance the start timing of the water injection as the engine load (demanded engine load) decreases. Note that the mode of change in the start timing of the water injection relative to the engine load is not limited to the one illustrated in FIG. 6.

Moreover, in the embodiment described above, the water-injection amount Q1 and the water-injection amount Q2 are switched between the first-load range R1 and the second-load range R2 (e.g., see FIG. 5). However, in another embodiment, the amount of water injection may be changed according to the engine load. In detail, in another embodiment, as illustrated in FIG. 7 (the horizontal axis indicates the engine load, and the vertical axis indicates the water-injection amount), when water is injected during the expansion stroke of the engine 1, the controller 10 may increase the amount of water injection as the engine load (demanded engine load) decreases. Note that the mode of change in the amount of water injection relative to the engine load is not limited to the one illustrated in FIG. 7.

Moreover, in still another embodiment, a ratio of the amount of water injection to the amount of fuel injection (the water-injection amount/the fuel-injection amount) may be changed according to the engine load. For example, the ratio of the water-injection amount to the fuel-injection amount may be increased as the engine load decreases.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### DESCRIPTION OF REFERENCE CHARACTERS

1 Engine

3 Piston

4 Water Injector

5 Water Supplier

10 Controller

11 Combustion Chamber

14 Cylinder

51 Condenser

52 Water Tank

53 Water Pump

54 Heat Exchanger

62 Exhaust Pipe

64 Injector

65 Ignition Plug

100 Engine System

SN1 Accelerator Opening Sensor

What is claimed is:

1. An engine system, comprising:
an engine configured to generate a motive force for a vehicle by combusting a mixture gas of fuel and intake air;
a water injector configured to inject heated water into a combustion chamber of the engine; and
a controller configured to control the water injector to inject the water into the combustion chamber during an expansion stroke of the engine,
wherein the controller acquires a demanded engine load of the engine, and controls the water injector to increase an amount of water injection when the demanded engine load is within a first-load range, compared to when the demanded engine load is within a second-load range where the engine load is higher than in the first-load range.

2. The engine system of claim 1, wherein the controller controls the water injector to advance a start timing of the water injection when the demanded engine load is within the first-load range, compared to when the demanded engine load is within the second-load range.

3. The engine system of claim 2, wherein the controller controls the water injector to further inject the water into the combustion chamber during a compression stroke of the engine.

4. The engine system of claim 3, wherein the water injector directly injects the heated water into the combustion chamber of the engine.

5. The engine system of claim 4, further comprising a heat exchanger provided to an exhaust pipe of the engine and configured to heat water with heat of exhaust gas of the engine,
wherein the water heated by the heat exchanger is supplied to the water injector.

6. An engine system, comprising:
an engine configured to generate a motive force for a vehicle by combusting a mixture gas of fuel and intake air;
a water injector configured to inject heated water into a combustion chamber of the engine; and
a controller configured to control the water injector to inject the water into the combustion chamber during an expansion stroke of the engine,
wherein the controller acquires a demanded engine load of the engine, and controls the water injector to increase an amount of water injection as the demanded engine load decreases.

7. The engine system of claim 1, wherein the controller controls the water injector to further inject the water into the combustion chamber during a compression stroke of the engine.

8. The engine system of claim 1, wherein the water injector directly injects the heated water into the combustion chamber of the engine.

9. The engine system of claim 1, further comprising a heat exchanger provided to an exhaust pipe of the engine and configured to heat water with heat of exhaust gas of the engine, wherein the water heated by the heat exchanger is supplied to the water injector.

10. The engine system of claim 2, wherein the water injector directly injects the heated water into the combustion chamber of the engine.

11. The engine system of claim 2, further comprising a heat exchanger provided to an exhaust pipe of the engine and configured to heat water with heat of exhaust gas of the engine,
wherein the water heated by the heat exchanger is supplied to the water injector.

12. The engine system of claim 3, further comprising a heat exchanger provided to an exhaust pipe of the engine and configured to heat water with heat of exhaust gas of the engine,
wherein the water heated by the heat exchanger is supplied to the water injector.

13. The engine system of claim 7, wherein the water injector directly injects the heated water into the combustion chamber of the engine.

14. The engine system of claim 7, further comprising a heat exchanger provided to an exhaust pipe of the engine and configured to heat water with heat of exhaust gas of the engine,
wherein the water heated by the heat exchanger is supplied to the water injector.

15. The engine system of claim 8, further comprising a heat exchanger provided to an exhaust pipe of the engine and configured to heat water with heat of exhaust gas of the engine,
wherein the water heated by the heat exchanger is supplied to the water injector.

16. The engine system of claim 10, further comprising a heat exchanger provided to an exhaust pipe of the engine and configured to heat water with heat of exhaust gas of the engine,
wherein the water heated by the heat exchanger is supplied to the water injector.

17. The engine system of claim 13, further comprising a heat exchanger provided to an exhaust pipe of the engine and configured to heat water with heat of exhaust gas of the engine,
wherein the water heated by the heat exchanger is supplied to the water injector.

18. The engine system of claim 1, wherein the controller controls the water injector to advance a start timing of the water injection as the demanded engine load decreases.

19. The engine system of claim 1, wherein the controller controls the water injector to increase the amount of water injection as the demanded engine load decreases.

20. The engine system of claim 1, wherein the controller changes a ratio of the amount of water injection to an amount of fuel injection, and controls the water injector to increase the amount of water injection as the demanded engine load decreases.
